(19) United States
(12) Patent Application Publication
(10) Pub. No.: US 2020/0047578 A1
(43) Pub. Date: Feb. 13, 2020

(54) DUAL COMPOUND ELASTOMER BUSHING FOR VEHICLE SUSPENSION COMPONENT

(71) Applicants: GM Global Technology Operations LLC, Detroit, MI (US); Tenneco, Inc., Milan, OH (US)

(72) Inventors: Matthew G. Wieczorek, Imlay, MI (US); Balbir S. Sangha, Ajax (CA); Thomas Billerman, Sandusky, OH (US); Cameron M. Brant, Ashland, OH (US); Joseph F. Cerri, III, Norwalk, OH (US)

(21) Appl. No.: 16/100,575

(22) Filed: Aug. 10, 2018

(51) Int. Cl. B60G 11/12; F16F 1/38

(52) U.S. Cl. CPC B60G 11/12; B60G 2204/41; B60G 2204/121; F16F 1/38

(57) ABSTRACT

A dual compound bushing includes a tube having a first end, a second end, and an intermediate portion extending therebetween. A first elastomeric member having a first durometer value is arranged on the intermediate portion. A second elastomeric member having a second durometer value that is distinct from the first durometer value is arranged at the first end. A ferrule is mounted to the tube at the first end. The second elastomeric member being arranged between the ferrule and the first elastomeric member.

### INTRODUCTION

The subject disclosure relates to the art of vehicles and, more particularly, to a dual compound elastomer bushing for a vehicle suspension component.

Vehicles include a number of suspension components that operate to dampen vibrations, and other forces, that may transmit from road surfaces into occupant spaces. Suspension components may include coil springs, hydraulic pistons such as shock absorbers and struts, and leaf springs. Leaf springs are typically secured to a vehicle frame through a shackle. The shackle is supported at the leaf spring through elastomeric bushings. The elastomeric bushings serve to dampen forces and reduce wear at contact points between the leaf spring and the vehicle frame. Current bushings are typically a two part construction. That is, two metal sleeves sandwich an elastomeric material to form the bushing.

While effective at dampening and reducing wear, current bushings possess various limitations including the ability to provide both axial and conical stiffness. As such, materials that may be used to form suspension components, such as leaf springs, are limited. That is, if the bushings cannot provide a selected stiffness, suspension components, such as leaf springs, formed from certain lighter weight materials may not meet desired lateral stiffness requirements. Accordingly, it is desirable to provide a bushing with selected axial and conical stiffness so as to open the door to new materials that may be used in forming vehicle suspension components.

### SUMMARY

In one exemplary embodiment, a dual compound bushing including a tube having a first end, a second end, and an intermediate portion extending therebetween. A first elastomeric member having a first durometer value is arranged on the intermediate portion. A second elastomeric member having a second durometer value that is distinct from the first durometer value is arranged at the first end. A ferrule is mounted to the tube at the first end. The second elastomeric member being arranged between the ferrule and the first elastomeric member.

In addition to one or more of the features described above or below, or as an alternative, further embodiments could include a third elastomeric member arranged at the second end of the tube, the third elastomeric member including the second durometer value.

In addition to one or more of the features described above or below, or as an alternative, further embodiments could include another ferrule mounted to the tube at the second end, the third elastomeric member being arranged between the another ferrule and the first elastomeric member.

In addition to one or more of the features described above or below, or as an alternative, further embodiments could include wherein the first elastomeric member is mold bonded to the tube.

In addition to one or more of the features described above or below, or as an alternative, further embodiments could include wherein the ferrule is press-fit to the first end of the tube.

In addition to one or more of the features described above or below, or as an alternative, further embodiments could include wherein the first elastomeric member is integrally bonded with the second elastomeric member.

In addition to one or more of the features described above or below, or as an alternative, further embodiments could include wherein the second elastomeric member is formed from a self-lubricating elastomer.

In addition to one or more of the features described above or below, or as an alternative, further embodiments could include wherein the first durometer value is about 55 durometer and the second durometer value is about 75 durometer.

In accordance with another aspect of an exemplary embodiment, a method of forming a dual compound bushing includes mounting a first elastomeric member having a first durometer value about an intermediate portion of a tube, positioning a second elastomeric member having a second durometer value distinct from the first durometer value at a first end of the tube, and securing the second elastomeric member to the tube with a ferrule.

In addition to one or more of the features described above or below, or as an alternative, further embodiments could include wherein securing the second elastomeric member to the tube includes press-fitting the ferrule to the tube.

In addition to one or more of the features described above or below, or as an alternative, further embodiments could include positioning a third elastomeric member having the second durometer value distinct from the first durometer value at a first end of the tube, and securing the third elastomeric member to the tube with another ferrule.

In addition to one or more of the features described above or below, or as an alternative, further embodiments could include wherein securing the third elastomeric member to the tube includes applying a compression force to the first elastomeric member with the ferrule and the another ferrule.

In addition to one or more of the features described above or below, or as an alternative, further embodiments could include wherein mounting the first elastomeric member to the tube includes mold bonding the first elastomeric member to the tube.

In addition to one or more of the features described above or below, or as an alternative, further embodiments could include bonding the second elastomeric member to the first elastomeric member.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a partial view of a suspension component coupled to a vehicle with a dual compound bushing, in accordance with an aspect of an exemplary embodiment;

FIG. 2 is a perspective view of the dual compound bushing of FIG. 1, in accordance with an aspect of an exemplary embodiment; and

FIG. 3 is a cross-sectional view of the dual compound bushing of FIG. 2, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

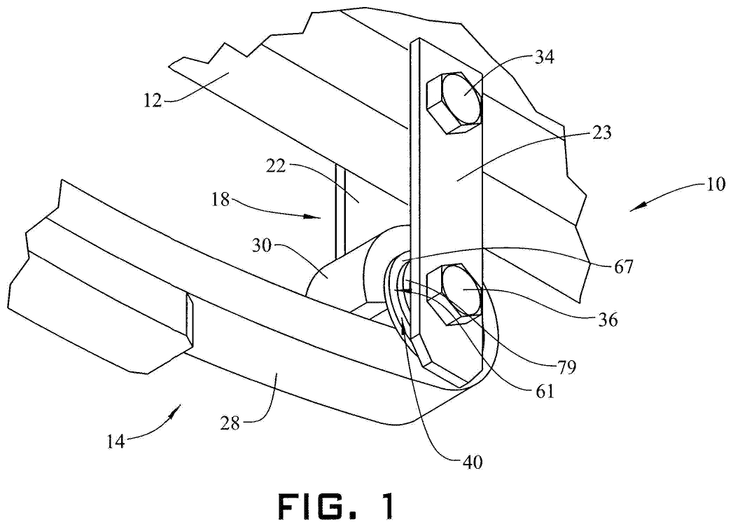

A vehicle, in accordance with an exemplary embodiment, is indicated generally at 10 in FIG. 1, vehicle 10 includes a frame 12 that supports a suspension component 14. Suspension component 14 supports an axle (not shown) which, in turn, supports a wheel (also not shown). Suspension component 14 is coupled to frame 12 through a shackle 18 having a first shackle component 22 and a second shackle component 23.

In an embodiment, suspension component 14 takes the form of a leaf spring 28 including a bushing receiver 30. A first mechanical fastener 34 secures shackle 18 to frame 12. A second mechanical fastener 36 secures leaf spring 28 to shackle 18. In an embodiment, a dual compound bushing 40 is arranged in bushing receiver 30 and supports leaf spring 28 to shackle 18.

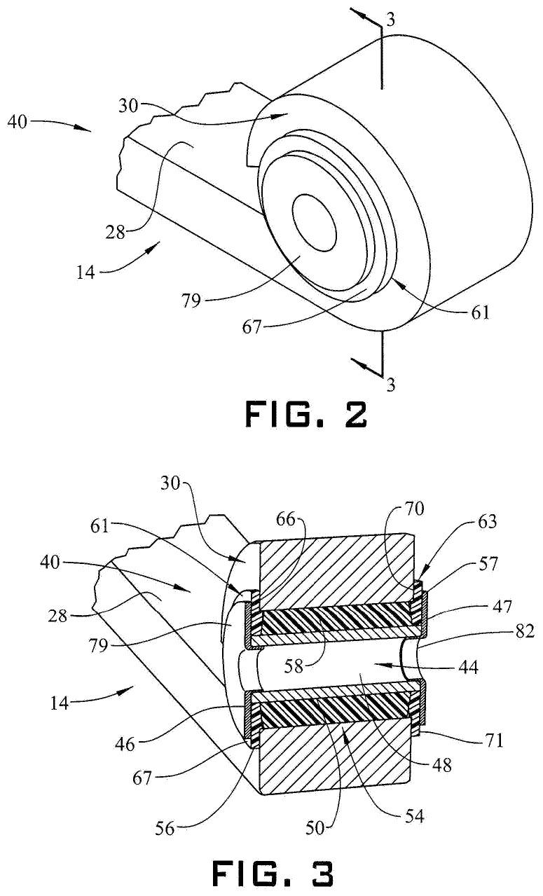

Referring to FIGS. 2 and 3, and with continued reference to FIG. 1, dual compound bushing 40, in accordance with an exemplary embodiment, includes a tube 44. Tube 44 may be formed from steel, an Aluminum extrusion or other materials depending upon vehicle requirements. Further, tube 44 may possess various cross-sectional geometries including circular or oval cross-sections depending on application or vehicle requirements. Tube 44 includes a first end 46, a second end 47, and an intermediate portion 48. Tube 44 also includes an outer surface 50 that extends between first end 46 and second end 47. In an embodiment, tube 44 supports a first elastomeric member 54. More specifically, first elastomeric member 54 may be mold bonded to intermediate portion 48 of tube 44. First elastomeric member 54 is formed from a first material having a first durometer value. In an embodiment, the first durometer value is about 55 durometer.

In further accordance with exemplary embodiments, a second elastomeric member 61 is arranged at first end 46 of tube 44 and a third elastomeric member 63 is arranged at second end 47 of tube 44. In an embodiment, second elastomeric member 61 is formed from a second material having a second durometer value. In accordance with an exemplary aspect, the second durometer value greater than the first durometer value. For example, the second durometer value may be about 75 durometer. Thus, second elastomeric member 61 is stiffer than first elastomeric member 54. Third elastomeric member 63 is formed from a third material having a third durometer value. In accordance with an exemplary aspect, third elastomeric member is formed from the second material. As such, the third durometer value is the same as the second durometer value. It should be understood that the particular durometer values may vary and could depend upon application and/or vehicle requirements. In another aspect, second and third elastomeric members may be formed from a self-lubricating elastomer.

In an embodiment, second elastomeric member 61 includes an inner surface 66 and an outer surface 67. Inner surface 61 may be spaced from first elastomeric member 54 at first end 46 of tube 44. In an embodiment, inner surface 61 may abut first elastomeric member 54. In another embodiment, inner surface 61 may be bonded to and/or integrally formed with first elastomeric member 54. Similarly, third elastomeric member 63 includes an inner surface 70 and an outer surface 71. Inner surface 70 may be spaced from first elastomeric member 54 at second end 47 of tube 44. In another embodiment, inner surface 70 may be bonded to and/or integrally formed with first elastomeric member 54. In yet another embodiment, first elastomeric member 54, second elastomeric member 61 and third elastomeric member 63 may be co-molded into tube 44.

In an embodiment, inner surface 70 may abut first elastomeric member 54. In another embodiment, inner surface 70 may be bonded to and/or integrally formed with first elastomeric member 54. For example, second and third elastomeric members 61 and 63 may be vulcanized to first elastomeric member 54. In another example, first, second, and third elastomeric members may be molded together using multiple injection nozzles that deliver different materials.

In further accordance with an exemplary aspect, a first ferrule 79 is arranged at first end 46 of tube 44 and a second ferrule 82 is arranged at second end 47 of tube 44. First ferrule 79 may be press-fit onto tube 44 at first end 46. Second ferrule 82 may be press-fit onto second end 47 of tube 44. In accordance with an exemplary aspect, first and second ferrules 79 and 82 may be mounted to tube 44 such that a compressive force is applied to second elastomeric member 61 and third elastomeric member 63. In an embodiment, the compressive force may provide a pre-load on second elastomeric member 61 and third elastomeric member 63. The pre-load may cause first and second ferrules 79 and 82 to compress corresponding ones of second elastomeric member 61 and third elastomeric member 63 about 0.5 mm. Dual compound bushing 40 may be installed into bushing receiver 30 using a variety of techniques. For example, first elastomeric member 54 may be mechanically bonded to leaf spring 28 at bushing receiver 30.

At this point, it should be appreciated that the exemplary embodiments describe a dual compound bushing that is formed from materials that are specifically selected to achieve selected axial and conical stiffness values. The ability to tune both the axial and conical stiffness values will open up a wide array of materials that may be used for suspension components. For example, dual compound bushing may be formed to provide selected axial and conical stiffness values that allow the use of various composite materials that will result in a significant weight savings.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A dual compound bushing comprising:
a tube including a first end, a second end, and an intermediate portion extending therebetween;
a first elastomeric member having a first durometer value arranged on the intermediate portion;
a second elastomeric member having a second durometer value that is distinct from the first durometer value arranged at the first end; and
a ferrule mounted to the tube at the first end, the second elastomeric member being arranged between the ferrule and the first elastomeric member.

2. The dual compound bushing according to claim 1, further comprising: a third elastomeric member arranged at the second end of the tube, the third elastomeric member including the second durometer value.

3. The dual compound bushing according to claim 2, further comprising: another ferrule mounted to the tube at the second end, the third elastomeric member being arranged between the another ferrule and the first elastomeric member.

4. The dual compound bushing according to claim 1, wherein the first elastomeric member is mold bonded to the tube.

5. The dual compound bushing according to claim 1, wherein the ferrule is press-fit to the first end of the tube.

6. The dual compound bushing according to claim 1, wherein the first elastomeric member is integrally bonded with the second elastomeric member.

7. The dual compound bushing according to claim 1, wherein the second elastomeric member is formed from a self-lubricating elastomer.

8. The dual compound bushing according to claim 1, wherein the first durometer value is about 55 durometer and the second durometer value is about 75 durometer.

9. A method of forming a dual compound bushing comprising:
mounting a first elastomeric member having a first durometer value about an intermediate portion of a tube;
positioning a second elastomeric member having a second durometer value distinct from the first durometer value at a first end of the tube; and
securing the second elastomeric member to the tube with a ferrule.

10. The method of claim 9, wherein securing the second elastomeric member to the tube includes press-fitting the ferrule to the tube.

11. The method of claim 9, further comprising:
positioning a third elastomeric member having the second durometer value distinct from the first durometer value at a first end of the tube; and
securing the third elastomeric member to the tube with another ferrule.

12. The method of claim 11, wherein securing the third elastomeric member to the tube includes applying a compression force to the first elastomeric member with the ferrule and the another ferrule.

13. The method of claim 9, wherein mounting the first elastomeric member to the tube includes mold bonding the first elastomeric member to the tube.

14. The method of claim 9, further comprising: bonding the second elastomeric member to the first elastomeric member.
